(19) United States
(12) Patent Application Publication
(10) Pub. No.: US 2026/0211397 A1
(43) Pub. Date: Jul. 23, 2026

(54) ENERGY EFFICIENT MANUFACTURING

(71) Applicant: International Business Machines Corporation, Armonk, NY (US)

(72) Inventors: Vinod Anandram Valecha, Pune (IN); Binoy Thomas, Kozhikode (IN); Sarbajit Kumar Rakshit, Kolkata (IN); Sudheesh S. Kairali, Kozhikode (IN)

(21) Appl. No.: 19/026,775

(22) Filed: Jan. 17, 2025

(51) Int. Cl. G05B 19/4097

(52) U.S. Cl. CPC G05B 19/4097; G05B 2219/32021

(57) ABSTRACT

Examples described herein provide a computer-implemented method for energy efficient manufacturing that includes receiving a design of an object to be manufactured and analyzing the design of the object to be manufactured to segment the object to be manufactured into components. The method further includes performing a comparative evaluation between wastage of materials and power consumption across different types of manufacturing processes to manufacture the components of the object. The method further includes calculating a sustainability score for each of the types of manufacturing processes for each of the components. The method further includes selecting a manufacturing process for each of the components based at least in part on the sustainability score for each of the types of manufacturing processes for each of the components and manufacturing each of the components using the selected manufacturing process for each of the components.

### BACKGROUND

The present disclosure relates to manufacturing processes, and more specifically, to energy efficient manufacturing.

The manufacturing process of an object typically starts with designing or modeling the object. Then, raw materials are selected for manufacturing the object based on the desired properties of the final product. These materials are then shaped or formed using one or more different manufacturing processes, such as additive manufacturing, casting, forging, or machining. The object may undergo additional processes, such as heat treatment, surface finishing, or coating, to enhance its durability or appearance.

### SUMMARY

According to an embodiment, a computer-implemented method for energy efficient manufacturing is provided. The method includes receiving a design of an object to be manufactured and analyzing the design of the object to be manufactured to segment the object to be manufactured into components. The method further includes performing a comparative evaluation between wastage of materials and power consumption across different types of manufacturing processes to manufacture the components of the object. The method further includes calculating a sustainability score for each of the types of manufacturing processes for each of the components. The method further includes selecting a manufacturing process for each of the components based at least in part on the sustainability score for each of the types of manufacturing processes for each of the components and manufacturing each of the components using the selected manufacturing process for each of the components.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to an embodiment;

FIG. 2 illustrates a block diagram of an object to be manufactured using one or more manufacturing processes, according to an embodiment;

FIG. 3 illustrates a flow diagram of a method for energy efficient manufacturing, according to an embodiment;

FIG. 4A and FIG. 4B together illustrate a flow diagram of a method for energy efficient manufacturing, according to an embodiment;

FIG. 5A and FIG. 5B together illustrate a flow diagram of a method for energy efficient manufacturing, according to an embodiment; and

FIG. 6 illustrates a flow diagram of a method for energy efficient manufacturing, according to an embodiment.

### DETAILED DESCRIPTION

One or more embodiments described herein provide for energy efficient manufacturing. More particularly, one or more embodiments provide for selecting combinations of manufacturing processes based on sustainability scores for each type of manufacturing process to ensure energy efficient manufacturing.

Manufacturing processes have evolved significantly, offering various methods such as computer numerical control (CNC) metal cutting, additive manufacturing (also referred to as three-dimensional (3D) printing), metal injection molding, metal forming, punching, bending, and/or the like, including combinations and/or multiples thereof. Each type of manufacturing process presents characteristics and energy requirements, impacting the overall sustainability of the manufacturing process. The choice of raw materials, such as metal bars or powder, further influences the energy consumption and material wastage associated with these processes. As industries strive for sustainable manufacturing, optimizing power consumption and minimizing material wastage have become desirable.

Existing types of manufacturing processes, while effective, often result in significant material wastage and energy consumption. For instance, CNC machining, though efficient in shaping materials, can lead to substantial material wastage. On the other hand, 3D printing, particularly techniques like selective laser melting, demands high energy input, sometimes exceeding that of conventional methods like CNC machining. The energy-intensive nature of converting metals into powder for 3D printing further exacerbates the power requirements of 3D printing. These challenges highlight the need for a more sustainable approach to manufacturing that balances energy efficiency with material conservation.

One or more embodiments described herein addresses these challenges by providing for selecting combinations of types of manufacturing processes and/or raw materials based on sustainability considerations, which are expressed as sustainability scores. One or more embodiments analyzes geometry of an object to be manufactured, material volume, and raw material specifications to perform a comparative evaluation of material wastage and power consumption across different types of manufacturing processes. By leveraging historical data and environmental parameters, one or more embodiments calculates a sustainability score for each type of manufacturing process, enabling the selection of optimal manufacturing processes that maximize sustainability. This approach not only optimizes power consumption but also minimizes material wastage, contributing to a more sustainable manufacturing future.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

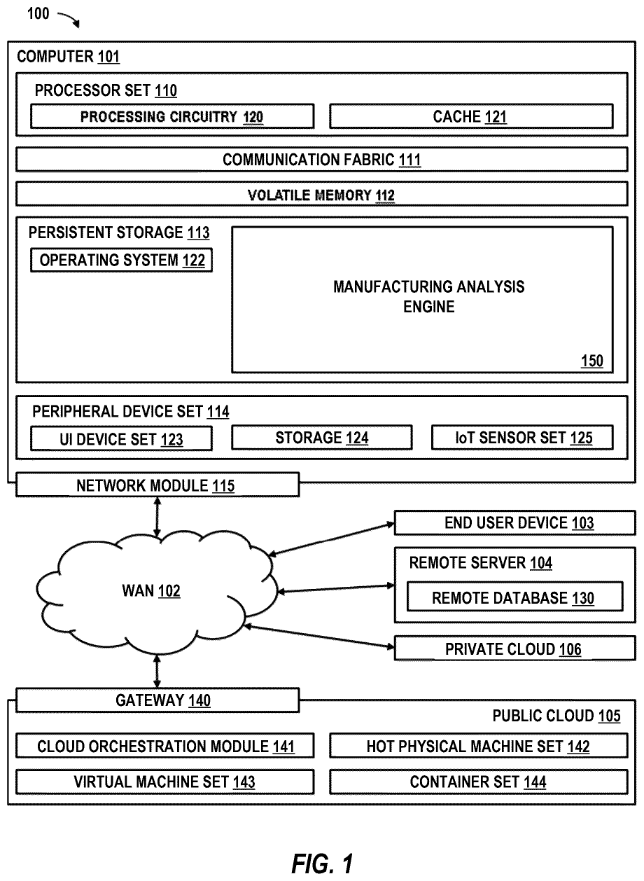

FIG. 1 illustrates a computing environment 100, according to an embodiment. Computing environment 100 contains an example of an environment for the execution of at least some of the computer code involved in performing the inventive methods, such as a manufacturing analysis engine 150 for analyzing manufacturing processes for manufacturing an object. In addition to the manufacturing analysis engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the manufacturing analysis engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the manufacturing analysis engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the manufacturing analysis engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The manufacturing analysis engine 150 provides for analyzing the geometry of an object to be manufactured, a volume of material required to manufacture the object, available types of raw materials (e.g., powder material, raw materials bar, material filament, etc.), specifications of raw material (e.g., metal vs plastic, etc.) and/or the like, including combinations and/or multiples thereof. The manufacturing analysis engine 150 can use historical learning to perform comparative evaluation between wastage of material and power consumption across different types of manufacturing processes to manufacture the object and can rank the types of manufacturing processes based on sustainability score. The sustainability score is a function of power requirements and wastage of material for a type of manufacturing process and how those wastage of material can be used.

According to one or more embodiments, based on the geometry and dimension of the object, types of available raw material, the manufacturing analysis engine 150 can determine whether the same object can be manufactured with multiple combinations of manufacturing process, so that, to manufacture the object, the aggregated sustainability score can be maximized for that object.

According to one or more embodiments, the manufacturing analysis engine 150 analyzes the objects to be manufactured, their shapes, dimensions and geometry, positives and negatives of the types of manufacturing processes, and estimated sustainability score to manufacture the object. The manufacturing analysis engine 150 can then identify what types of raw materials (e.g., powder material, raw materials bar, material filament, etc.), will cause increases in sustainability scores to when manufacturing the object.

According to one or more embodiments, if multiple types of objects are to be manufactured, then based on the geometry of the objects in different sections of the object, the manufacturing analysis engine 150 identifies appropriate types and specifications of the raw materials, so that wastage of materials can be minimized, and also the sustainability score can be optimized.

According to one or more embodiments, the manufacturing analysis engine 150 can consider the historical data related to environmental parameters (e.g., power consumption, material wastage, carbon footprint, water usage, chemical emissions, use of coolant, fume generation, and any other relevant environmental factors), and can use the same parameters for calculating the sustainability score. The manufacturing analysis engine 150 can then identify how the object is to be manufactured so that the sustainability score is optimum.

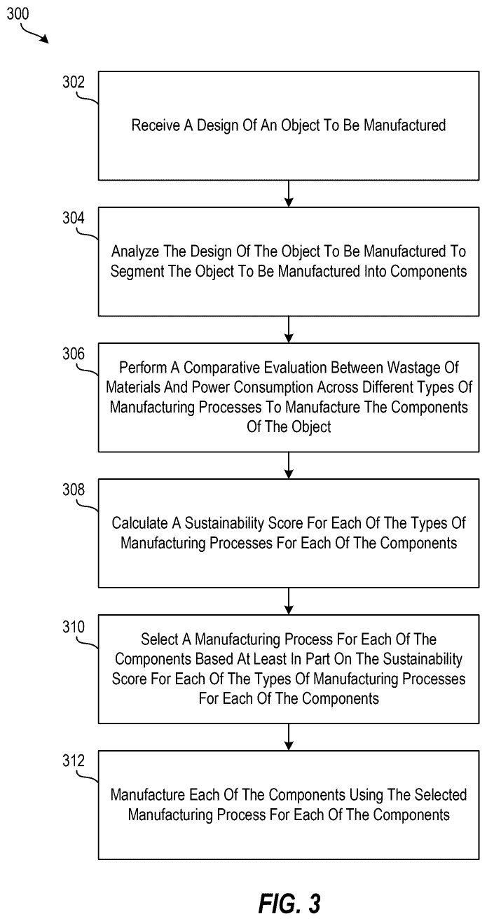

Further features of the manufacturing analysis engine 150 are now described in more detail with references to FIGS. 3, 4A, 4B, 5A, and 5B, but are not so limited.

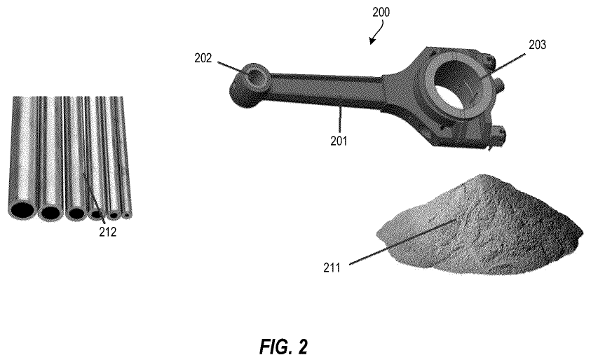

FIG. 2 illustrates a block diagram of an object 200 to be manufactured using one or more manufacturing processes, according to an embodiment. The object 200 can be any suitable object that can be manufactured from raw materials. In FIG. 2, the object 200 is a cam shaft, but the one or more embodiments described herein are applicable to many different types of objects and are not limited to cam shafts.

The object 200 includes multiple components, including component 201, component 202, and component 203. The components 201-203 can be manufactured using the same or different raw materials and can be manufactured using the same or different manufacturing processes.

For example, the component 201 can be manufactured using additive manufacturing (e.g., three-dimensional (3D) printing) from powder material 211. The component 202 can be manufactured using a boring metal cutting machining process using metal rods 212. The component 203 can be manufactured using a boring metal machining process also using the metal rods 212. Other types of manufacturing processes and/or raw materials can be used to manufacture the components 201-203 of the object 200 in various embodiments.

Turning now to FIG. 3, a flow diagram of a method 300 for energy efficient manufacturing is provided, according to an embodiment. The method 300 can be performed by any suitable computing system, device, or environment, such as those described herein. The method 300 is now described with reference to the computing environment 100, and particularly the manufacturing analysis engine 150, but is not so limited. For example, the method 300 is performed by the manufacturing analysis engine 150 and involves several steps to analyze the manufacturing process for an object, such as the object 200 of FIG. 2.

While manufacturing any suitable object (e.g., the object 200 of FIG. 2), if the object can be manufactured with multiple manufacturing processes, then one or more embodiments described herein can be implemented to evaluate the object to select what types of or combinations of manufacturing to implement to manufacture the object for any given raw materials so that energy efficiency is optimized.

Block 302 initiates the method 300, where the manufacturing analysis engine 150 receives a design of an object to be manufactured, such as the object 200 of FIG. 2. This step involves obtaining the specifications and requirements of the object, which serves as the foundation for subsequent analysis and decision-making.

At block 304, the manufacturing analysis engine 150 analyzes the design of the object to segment the object into components (e.g., the components 201-203 of the object 200 of FIG. 2). This analysis considers the geometry, dimensions, and other relevant characteristics of the object to determine how the object can be divided into manageable parts for manufacturing.

At block 306, the manufacturing analysis engine 150 performs a comparative evaluation between wastage of materials and power consumption across different types of manufacturing processes to manufacture the components of the object. This evaluation leverages historical data and environmental parameters to assess the efficiency and sustainability of various manufacturing options.

At block 308, the manufacturing analysis engine 150 calculates a sustainability score for each of the types of manufacturing processes for each of the components. The sustainability score is determined based on factors such as power consumption, material wastage, and environmental impact, providing a quantitative measure of each process's sustainability. According to one or more embodiments, the sustainability score is calculated with multiple coefficient factors based on industry time and location. Consider, for example, a location where electricity production is based on thermal power plant and solar systems. For such an example, the sustainability score is relatively higher for a factory operating during daytime (e.g., when the factory uses power from solar power plant) rather than during nighttime (e.g., when the factory uses power from a thermal power plant). In this case, even though the power consumption is same, the coefficient factor of the environmental impact based on time of day changed the sustainability score.

At block 310, the manufacturing analysis engine 150 selects a manufacturing process for each of the components based at least in part on the sustainability score for each of the types of manufacturing processes for each of the components. This selection aims to optimize the overall sustainability of the manufacturing process by choosing the most efficient and environmentally friendly options.

Block 312 concludes the method 300, where each of the components is manufactured using the selected manufacturing process for each of the components. This step involves executing the chosen processes to produce the object by manufacturing the individual components that together form the object, ensuring that the manufacturing is conducted in an energy-efficient and sustainable manner.

Additional processes also may be included, and it should be understood that the processes depicted in FIG. 3 represent illustrations, and that other processes may be added or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

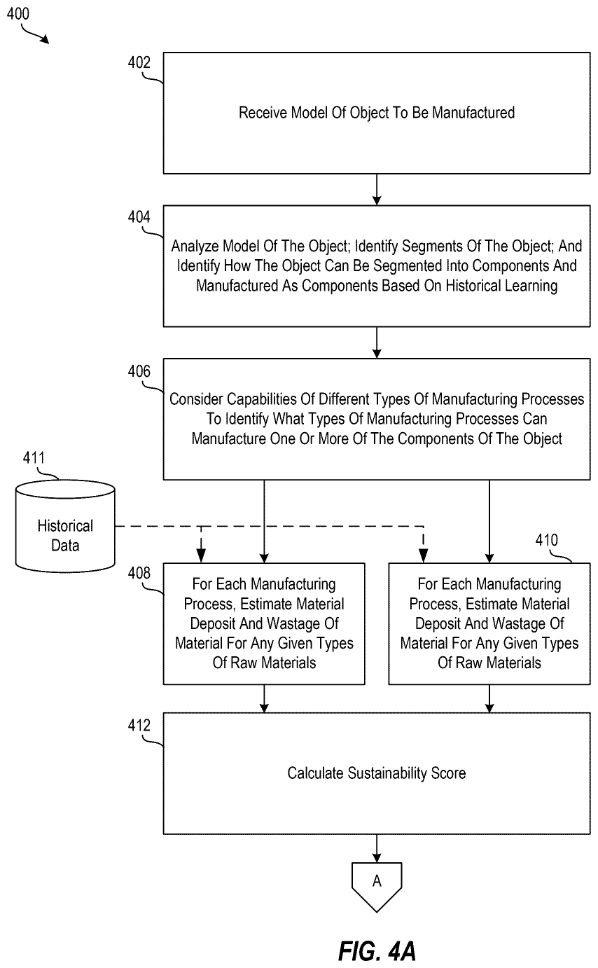

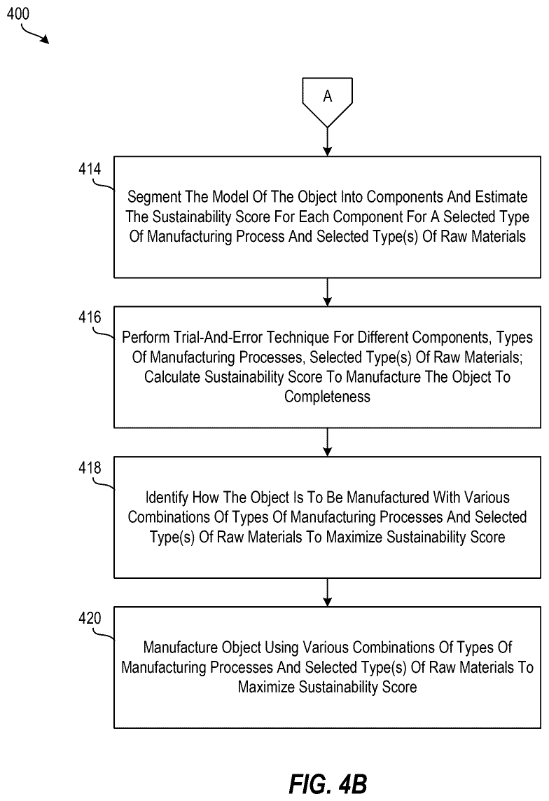

Turning now to FIGS. 4A and 4B together, a flow diagram of a method 400 for energy efficient manufacturing is provided, according to an embodiment. The method 400 can be performed by any suitable computing system, device, or environment, such as those described herein. The method 400 is now described with reference to the computing environment 100, and particularly the manufacturing analysis engine 150, but is not so limited. For example, the method 400 is performed by the manufacturing analysis engine 150 and involves several steps to analyze the manufacturing process for an object, such as the object 200 of FIG. 2.

While manufacturing any suitable object (e.g., the object 200 of FIG. 2), if the object can be manufactured with multiple manufacturing processes, then one or more embodiments described herein can be implemented to evaluate the object to select what types of or combinations of manufacturing to implement to manufacture the object for any given raw materials so that energy efficiency is optimized.

Turning now to FIG. 4A, FIG. 4A shows a portion of the method 400 for energy efficient manufacturing. The method begins at block 402, where the manufacturing analysis engine 150 receives a model of the object (e.g., the object 200 of FIG. 2) to be manufactured. This model serves as the basis for further analysis and segmentation.

At block 404, the manufacturing analysis engine 150 analyzes the model of the object to identify segments and determine how the object can be divided into components. According to one or more embodiments, the analysis leverages historical learning to inform the segmentation process, ensuring that the object is divided in a manner conducive to efficient manufacturing. Historical learning refers to the process of utilizing past data and experiences to inform current decision-making. In the context of energy efficient manufacturing, historical learning involves analyzing historical data 411 related to various types of manufacturing processes, such as power consumption, material wastage, and environmental impact. Historical data 411 is utilized to inform the decision-making process. This data provides insights into past manufacturing outcomes, helping to refine the selection of manufacturing processes and raw materials. For example, the manufacturing analysis engine 150 can utilize historical data 411 to identify patterns and trends that can guide the selection of optimal manufacturing processes. By leveraging historical insights, the manufacturing analysis engine 150 can enhance the accuracy of sustainability scores and improve the overall efficiency and sustainability of the manufacturing process.

Block 406 involves the manufacturing analysis engine 150 considering the capabilities of different types of manufacturing processes. The manufacturing analysis engine 150 identifies which types of manufacturing processes can produce one or more components of the object (e.g., the components 201-203 of the object 200 of FIG. 2), taking into account the specific capabilities and limitations of each type of manufacturing process.

Blocks 408 and 410 focus on estimating material deposit and wastage for each manufacturing process. For any given types of raw materials, the manufacturing analysis engine 150 evaluates how much material is required and how much is likely to be wasted, providing a detailed assessment of material efficiency, which is determined at least in part using the historical data 411.

At block 412, the manufacturing analysis engine 150 calculates a sustainability score as described herein. This score reflects the efficiency and environmental impact of each of the types of manufacturing processes, guiding the selection of the most sustainable options for producing the object and its components.

FIG. 4B continues the method 400 for energy efficient manufacturing. At block 414, the manufacturing analysis engine 150 segments the model of the object is components and estimates the sustainability score for each component. The sustainability score is estimated based on a selected type of manufacturing process (e.g., additive manufacturing) and selected types of raw materials (e.g., powder material).

Block 416 involves the manufacturing analysis engine 150 performing a trial-and-error technique for different components, types of manufacturing processes, and selected raw materials. The trial-and-error technique involves iteratively testing different combinations of manufacturing processes and raw materials to determine the most efficient way to manufacture an object or its components. This technique evaluates the sustainability scores of various options by gradually selecting incremental portions of the object and assessing the impact of different manufacturing strategies, for example. By experimenting with different configurations, the manufacturing analysis engine 150 identifies the combination of type of manufacturing process and raw material that maximizes the sustainability score for the component and/or object, ensuring optimal energy efficiency and minimal material wastage throughout the manufacturing process.

At block 418, the manufacturing analysis engine 150 identifies how the object is to be manufactured using various combinations of manufacturing processes and selected raw materials. The goal is to maximize the sustainability score by choosing the optimal combination.

Finally, at block 420, the object is manufactured using the identified combinations of manufacturing processes and raw materials, ensuring that the sustainability score is maximized throughout the process.

Additional processes also may be included, and it should be understood that the processes depicted in FIG. 4 represent illustrations, and that other processes may be added or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

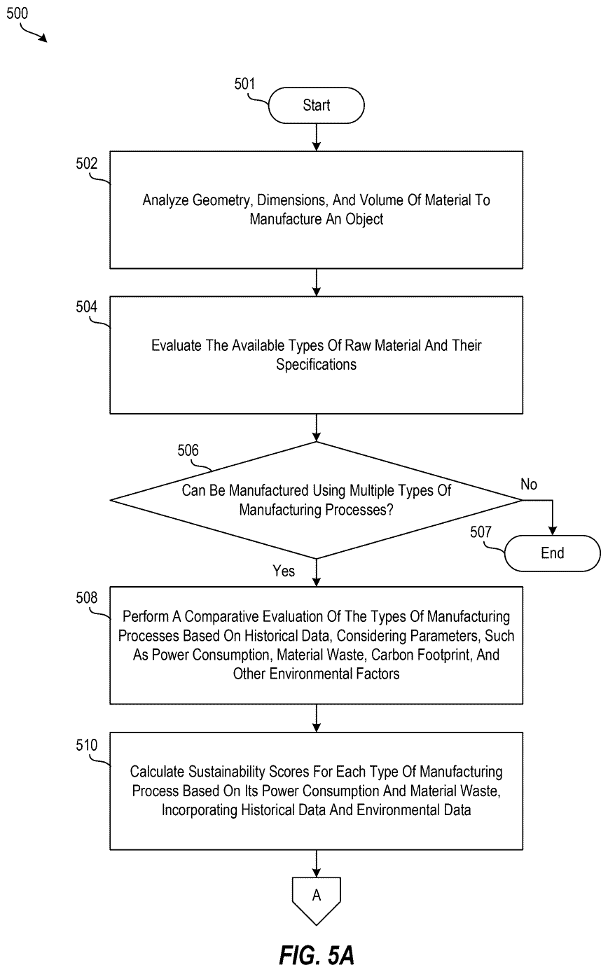

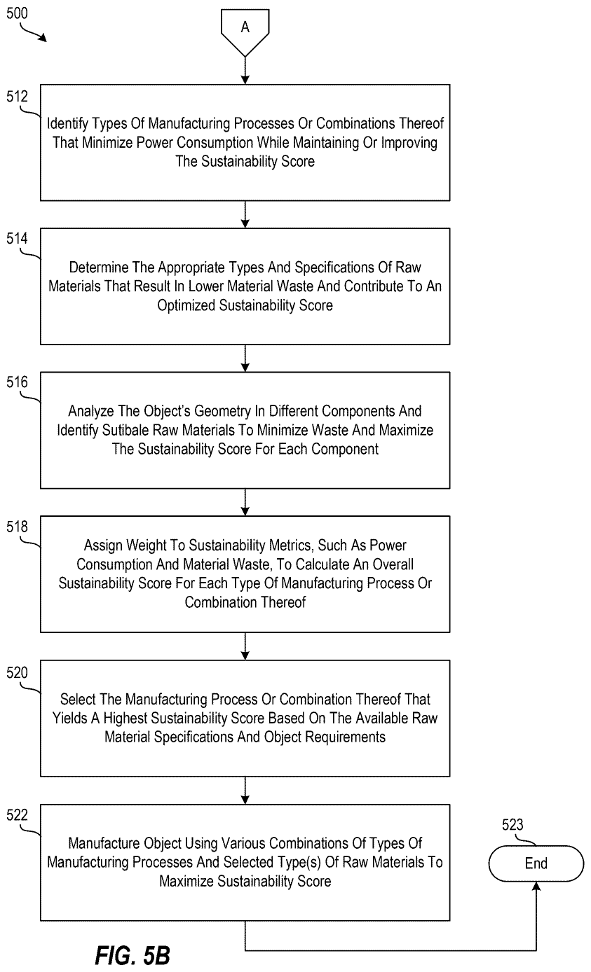

Turning now to FIGS. 5A and 5B together, a flow diagram of a method 500 for energy efficient manufacturing is provided, according to an embodiment. The method 500 can be performed by any suitable computing system, device, or environment, such as those described herein. The method 500 is now described with reference to the computing environment 100, and particularly the manufacturing analysis engine 150, but is not so limited. For example, the method 500 is performed by the manufacturing analysis engine 150 and involves several steps to analyze the manufacturing process for an object, such as the object 200 of FIG. 2.

While manufacturing any suitable object (e.g., the object 200 of FIG. 2), if the object can be manufactured with multiple manufacturing processes, then one or more embodiments described herein can be implemented to evaluate the object to select what types of or combinations of manufacturing to implement to manufacture the object for any given raw materials so that energy efficiency is optimized.

The method 500 starts at block 501, where the process initiates the analysis of the object to be manufactured.

At block 502, the manufacturing analysis engine 150 analyzes the geometry, dimensions, and volume of material used to manufacture the object (e.g., the object 200 of FIG. 2). This step is useful for understanding the physical characteristics and material needs of the object, which informs subsequent decisions in the manufacturing process.

Block 504 involves the manufacturing analysis engine 150 evaluating the available types of raw material and their specifications. This evaluation considers the different raw materials that can be used, such as powder material, raw materials bar, and material filament, and their respective properties, such as metal versus plastic.

At decision block 506, the manufacturing analysis engine 150 determines whether the object can be manufactured using multiple types of manufacturing processes. If the answer is no, the method 500 ends at block 507, concluding the method 500. If the answer is yes, the method 500 continues to block 508.

At block 508, the manufacturing analysis engine 150 performs a comparative evaluation of the types of manufacturing processes based on historical data. This evaluation considers parameters such as power consumption, material waste, carbon footprint, and other environmental factors, providing a comprehensive assessment of the sustainability of each manufacturing option.

Block 510 involves the manufacturing analysis engine 150 calculating sustainability scores for each type of manufacturing process based on the power consumption and material waste of the manufacturing process. This calculation incorporates historical data and environmental data to provide a quantitative measure of the sustainability of each process, guiding the selection of the most efficient and environmentally friendly manufacturing options.

FIG. 5B continues the method 500 for energy efficient manufacturing, executed by the manufacturing analysis engine 150.

At block 512, the manufacturing analysis engine 150 identifies types of manufacturing processes or combinations thereof that minimize power consumption while maintaining or improving the sustainability score. This step focuses on selecting processes that are both energy-efficient and sustainable.

At block 514, the manufacturing analysis engine 150 determines the appropriate types and specifications of raw materials that result in lower material waste and contribute to an optimized sustainability score. This involves selecting materials that align with sustainability goals.

At block 516, the manufacturing analysis engine 150 analyzes the object's geometry in different components and identifies suitable raw materials to minimize waste and maximize the sustainability score for each component. This step ensures that each part of the object is manufactured efficiently.

At block 518, the manufacturing analysis engine 150 assigns weights to sustainability metrics, such as power consumption and material waste, to calculate an overall sustainability score for each type of manufacturing process or combination. The weights are assigned to sustainability metrics reflect a metric's relative importance or priority in the overall sustainability assessment. By assigning weights, the manufacturing analysis engine 150 can emphasize certain criteria over others, ensuring that the most critical factors are given appropriate consideration in the calculation of the sustainability score. This weighted approach allows for a more tailored and accurate evaluation of each type of manufacturing process's sustainability, guiding the selection of the most efficient and environmentally friendly options.

At block 520, the manufacturing analysis engine 150 selects the manufacturing process or combination that yields the highest sustainability score based on the available raw material specifications and object requirements. This step ensures the most sustainable manufacturing approach is chosen.

Block 522 involves manufacturing the object using various combinations of types of manufacturing processes and selected raw materials to maximize the sustainability score. This step executes the chosen processes to produce the object sustainably.

The method 500 concludes at block 523, completing the method 500.

Additional processes also may be included, and it should be understood that the processes depicted in FIG. 5 represent illustrations, and that other processes may be added or existing processes may be removed, modified, or rearranged without departing from the scope of the present disclosure. It should also be understood that the processes depicted in FIG. 5 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

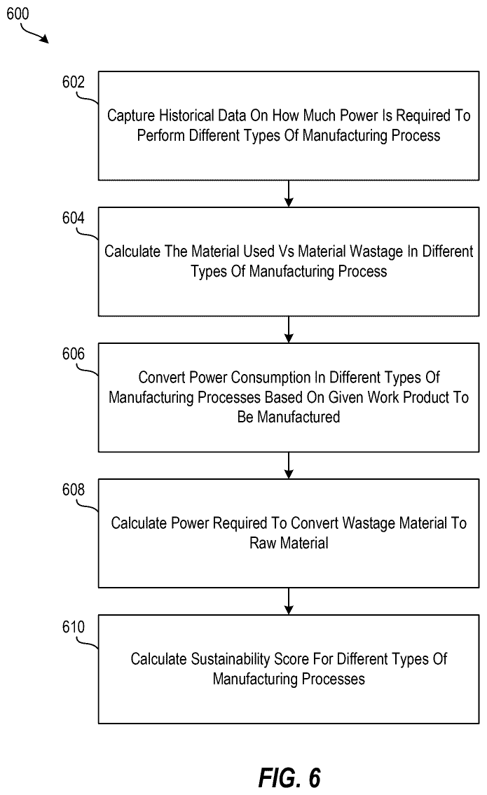

Turning now to FIG. 6, a flow diagram of a method 600 for energy efficient manufacturing is provided, according to an embodiment. The method 600 can be performed by any suitable computing system, device, or environment, such as those described herein. The method 600 is now described with reference to the computing environment 100, and particularly the manufacturing analysis engine 150, but is not so limited. For example, the method 600 is performed by the manufacturing analysis engine 150 and involves several steps to analyze the manufacturing process for an object, such as the object 200 of FIG. 2.

At block 602, the method 600 includes capturing historical data on how much power is required to perform different types of manufacturing process. According to one or more embodiments, predefined parameters are provided for comparing power consumption. Examples of such predefined parameters include, but are not limited to, energy consumption per unit of output, energy efficiency, specific energy consumption, power consumption by machine, material movement. The power required by machine can be in multiple modules, (e.g., for 3D printing, it can be heating module, computing module, movement of nozzle, etc.). According to one or more embodiments, data on power consumption is collected for each type of manufacturing process. This can be done by measuring energy usage directly or referring to technical specifications, energy consumption data provided by equipment manufacturers, or research studies. According to one or more embodiments, standardization of power consumption can be performed. For example, the collected data can be converted into a common unit (e.g., kilowatt-hours (kWh) or joules), to ensure accurate and fair comparisons. According to one or more embodiments, the total energy consumption for each manufacturing process steps can be calculated based on the gathered data and standardized units. This calculation can consider both the direct energy consumption of the machines/equipment involved and any auxiliary systems (e.g., cooling or support equipment). According to one or more embodiments, various factors can be considered that may affect power consumption in each manufacturing process, such as process duration, idle time, material utilization, and setup time. The energy consumption values can be adjusted accordingly to reflect these factors. According to one or more embodiments, the health condition of different machines and for different health conditions can be considered, including how much power consumption is required. According to one or more embodiments, the material specification can be considered, such as, melting points, hardness, bending stress, etc., and those specifications can be used as driving factors for power consumption. According to one or more embodiments, the types and specifications of the raw materials used for manufacturing different types of objects (e.g., 5 cm diameter circular bar, 10 cm diameter circular bar, powder material, filament, etc.) can be considered, including historical values for those types and specifications of the raw materials. Based on the historically captured data on power consumption, one or more embodiments can compare the energy consumption values obtained for each process. One or more embodiments identify trends, differences, and variations in power consumption between 3D printing, metal cutting, and forming processes, with combination of different types of objects, raw material specification etc. One or more embodiments can consider overall efficiency of each process in converting energy into useful output. A more efficient manufacturing process may yield relatively higher productivity with less energy consumption, for example.

At block 604, the method 600 includes calculating the material used versus material wastage in different types of manufacturing process. One or more embodiments can consider different types of manufacturing processes, such as direct material deposit, laser melting, metal cutting, capabilities of different types of machines, and/or the like, including combinations and/or multiples thereof. One or more embodiments can analyze the 3D model of the object that is to be manufactured, and accordingly estimate how much material deposit is required, and for any defined raw material specification, how much material removal is required. One or more embodiments can consider the power require for unit material deposit or unit material cutting, and can also consider the raw material specification (e.g., dimension, melting point, etc.). Based on the raw material specifications, and types, one or more embodiments can calculate input material quantities and specifications, as well as any data on expected wastage or scrap rates. This information can be obtained from technical specifications, equipment manufacturers, process documentation, or empirical studies. One or more embodiments can determine the total amount of material used in each process. This can be calculated by multiplying the material consumption rate per unit of output (e.g., per part, per volume) by the total output quantity. One or more embodiments can evaluate the amount of material wasted in each manufacturing process. This can be done by estimating or measuring the material that cannot be used for the final object due to trimming, machining, scrap, or other factors. One or more embodiments consider both pre-production wastage (e.g., trimming excess material from raw stock) and in-process wastage (e.g., material removed during machining). One or more embodiments can calculate the percentage of material wastage by dividing the material wastage amount by the total material used. This provides a quantitative measure of the wastage relative to the total material consumed. Considering the raw material specification, and the final object 3D model of the object to be manufactured, one or more embodiments can analyze the 3D model and identify what types of machining are required (e.g., drilling, turning, etc.). One or more embodiments can consider different machining processes and can estimate the volume of material removal to manufacturing the object.

At block 606, the method 600 includes converting power consumption in different types of manufacturing processes based on given object to be manufactured. Based on above historical data analysis, one or more embodiments can convert power consumption in different manufacturing processes based on the given object and raw material specifications. One or more embodiments can analyze the 3D model of the object to be manufactured to determine whether the object can be manufactured with different type of manufacturing processes, or various combination of manufacturing processes. One or more embodiments can identify what types of manufacturing process can be performed, such as 3D printing, and various unit material removal processes (e.g., milling, turning, drilling). One or more embodiments can include the power consumption values associated with the specific process, machine, or equipment used. This data can be obtained from technical specifications, equipment manufacturers, process documentation, or research studies. One or more embodiments can consider the raw material specifications for the work. This includes information such as material type, dimensions, and properties (e.g., hardness, density). These specifications are useful for calculating the power consumption in material removal processes. One or more embodiments can calculate material removal from different types of manufacturing processes, such as milling, turning, or drilling, and power consumption is directly related to the volume of material removed. One or more embodiments can use appropriate machining formulas and empirical data to calculate the energy required to remove a unit volume or weight of material based on the material properties and cutting conditions. One or more embodiments can apply the calculated material removal energy values to the given object specifications. One or more embodiments can multiply the material removal energy per unit volume or weight by the total volume or weight of material to be removed in the specific manufacturing process. This can provide an estimate of the power consumption required for material removal in the given process. One or more embodiments can also consider various factors, such as tooling efficiency, machine capability, cutting parameters, and process optimization. The accuracy of the power consumption estimation depends on the accuracy of the input data and the specific conditions of the manufacturing processes. For any given object that is to be manufactured, one or more embodiments can estimate how much power is required to manufacture the object can calculate the volume of wastage of material (e.g., metal chips, etc.).

At block 608, the method 600 includes calculating power required to convert wastage material to raw material. The wastage of material during metal cutting operation can be reused by converting those materials to raw material. One or more embodiments can use historical data for calculating the power required to convert wastage material, such as metal chips, into raw material, such as powder or bars. One or more embodiments can consider specific conversion process where the metal chips are processed, such as milling, grinding, or compaction, based on the desired output material form (e.g., powder or bar). Based on the actual data from different conversion process, one or more embodiments can assess the efficiency of the conversion process. This efficiency can be defined as the ratio of output material energy to input power energy. It reflects the effectiveness of the process in converting the input power into the desired output material. One or more embodiments can historically collect relevant data for the specific conversion process. This includes the power consumption values associated with the process or equipment used for the conversion. These data can be obtained from technical specifications, equipment manufacturers, process documentation, or research studies. One or more embodiments can calculate how much power is required to convert the wastage of material to raw material.

At block 610, the method 600 includes calculating a sustainability score for different types of manufacturing processes. While manufacturing any objects, One or more embodiments calculate sustainability scores for different manufacturing processes required to manufacture the object. In such cases, one or more embodiments can consider multiple factors, such as power consumption, material wastage, and environmental impact, or any industry specific parameters. One or more embodiments identify the sustainability criteria in the evaluation. These criteria can include power consumption, material wastage, carbon footprint, water usage, chemical emissions, and any other relevant environmental factors. While analyzing the 3D model of the object, one or more embodiments can estimate the wastage of material, material deposit, capability to different machines to manufacture different shape of the object, etc. One or more embodiments can consider any predefined or dynamic weights to each sustainability criterion based on its importance or priority. These weights reflect the relative significance of each criterion in the overall sustainability assessment (e.g., environmental impact is more important than power consumption or vice versa). One or more embodiments can segment the object into components considering the specification, shape, dimension of the object, with trial-and-error approach as described herein and can evaluate the sustainability score. During the trial-and-error approach, one or more embodiments can gradually select an incremental portion of the object and can evaluate the sustainability scores for different manufacturing processes and select appropriate segmentation of the object that can bring the optimum sustainability score.

Based on the analysis of the 3D object, one or more embodiments can use historical data for each manufacturing process and for each component of the object, specifically related to the identified sustainability criteria. This data can include power consumption values, material wastage percentages, energy source information, emissions data, water usage figures, and any other relevant information. One or more embodiments can consider multiply sustainability scores by its respective weight and sum up the weighted scores to obtain the overall sustainability score for each manufacturing process of different segment of the object. This step combines the individual sustainability scores into a single value that represents the sustainability performance of the manufacturing process. One or more embodiments can compare the sustainability scores of different manufacturing processes. According to one or more embodiments, the process with the highest sustainability score is considered the most sustainable according to the defined criteria, and manufacturing equipment is allocated to perform different manufacturing processes for the various components of the object.

Additional processes also may be included, and it should be understood that the processes depicted in FIG. 6 represent illustrations, and that other processes may be added or existing processes may be removed, modified, or rearranged without departing from the scope of the present disclosure. It should also be understood that the processes depicted in FIG. 6 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

One or more embodiments described herein for energy efficient manufacturing offer several advantages and technical benefits. By evaluating and selecting manufacturing processes based on sustainability scores, one or more embodiments ensures that energy consumption is minimized, leading to resource savings and reduced environmental impact. One or more embodiments provide the ability to analyze material usage and wastage, which allows for more efficient use of raw materials, minimizing waste and conserving resources. By incorporating environmental parameters and historical data, one or more embodiments provides a comprehensive assessment of sustainability, promoting environmentally friendly manufacturing practices. The use of historical learning and trial-and-error methods enables informed decision-making, allowing manufacturers to choose the most efficient and sustainable processes. The ability to evaluate multiple manufacturing processes and raw materials provides flexibility, enabling manufacturers to adapt to different production needs and constraints. By optimizing manufacturing processes, one or more embodiments described herein can lead to improved product quality and consistency, enhancing customer satisfaction and reducing waste. The reduction in energy and material costs contributes to overall efficiency, making the manufacturing process more economically viable and sustainable.

One or more embodiments described herein improves the functioning of a computer by utilizing advanced algorithms and data analysis to optimize manufacturing processes. By leveraging historical data and environmental parameters, one or more embodiments can efficiently calculate sustainability scores, enabling the selection of optimal manufacturing methods. This enhances the computer's ability to process complex data sets and make informed decisions, leading to more efficient energy use and reduced material wastage. The integration of trial-and-error techniques and historical learning further refines the decision-making process, allowing the computer to adapt to various manufacturing scenarios and constraints. Overall, these capabilities enhance the computer's performance in managing and optimizing manufacturing operations, contributing to more sustainable and cost-effective production.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for energy efficient manufacturing, the method comprising:
receiving a design of an object to be manufactured;
analyzing the design of the object to be manufactured to segment the object to be manufactured into components;
performing a comparative evaluation between wastage of materials and power consumption across different types of manufacturing processes to manufacture the components of the object;
calculating a sustainability score for each of the types of manufacturing processes for each of the components;
selecting a manufacturing process for each of the components based at least in part on the sustainability score for each of the types of manufacturing processes for each of the components; and
manufacturing each of the components using the selected manufacturing process for each of the components.

2. The computer-implemented method of claim 1, wherein analyzing the design of the object to be manufactured to segment the object to be manufactured into the components comprises applying historical information to identify how the object can be segmented and manufactured as the components.

3. The computer-implemented method of claim 1, wherein analyzing the design of the object to be manufactured to segment the object to be manufactured into the components is based at least in part on a specification of the object, a shape of the object, and dimensions of the object.

4. The computer-implemented method of claim 1, wherein the sustainability score is calculated for each of the types of manufacturing processes based at least in part on parameters of the types of manufacturing processes.

5. The computer-implemented method of claim 4, wherein the parameters of the types of manufacturing processes comprises at least power consumption, material wastage, and environmental impact.

6. The computer-implemented method of claim 4, wherein each of the parameters has an associated weight based on an importance or priority for each of the parameters.

7. The computer-implemented method of claim 1, further comprising updating the sustainability score for each of the types of manufacturing processes for each of the components by performing a trial-and-error technique.

8. The computer-implemented method of claim 7, wherein the trial-and-error technique comprises gradually selecting incremental portions of the object, evaluating the sustainability score of different manufacturing processes, performing segmentation of the object to determine the components that maximize the sustainability score for each of the types of manufacturing processes for each of the components.

9. A system comprising:
a memory comprising computer readable instructions; and
a processing device for executing the computer readable instructions, the computer readable instructions controlling the processing device to perform operations for energy efficient manufacturing, the operations comprising:
receiving a design of an object to be manufactured;
analyzing the design of the object to be manufactured to segment the object to be manufactured into components;
performing a comparative evaluation between wastage of materials and power consumption across different types of manufacturing processes to manufacture the components of the object;
calculating a sustainability score for each of the types of manufacturing processes for each of the components;
selecting a manufacturing process for each of the components based at least in part on the sustainability score for each of the types of manufacturing processes for each of the components; and
manufacturing each of the components using the selected manufacturing process for each of the components.

10. The system of claim 9, wherein analyzing the design of the object to be manufactured to segment the object to be manufactured into the components comprises applying historical information to identify how the object can be segmented and manufactured as the components.

11. The system of claim 9, wherein analyzing the design of the object to be manufactured to segment the object to be manufactured into the components is based at least in part on a specification of the object, a shape of the object, and dimensions of the object.

12. The system of claim 9, wherein the sustainability score is calculated for each of the types of manufacturing processes based at least in part on parameters of the types of manufacturing processes.

13. The system of claim 12, wherein the parameters of the types of manufacturing processes comprises at least power consumption, material wastage, and environmental impact.

14. The system of claim 12, wherein each of the parameters has an associated weight based on an importance or priority for each of the parameters.

15. The system of claim 9, wherein the operations further comprise updating the sustainability score for each of the types of manufacturing processes for each of the components by performing a trial-and-error technique.

16. The system of claim 15, wherein the trial-and-error technique comprises gradually selecting incremental portions of the object, evaluating the sustainability score of different manufacturing processes, performing segmentation of the object to determine the components that maximize the sustainability score for each of the types of manufacturing processes for each of the components.

17. A computer program product for energy efficient manufacturing, the computer program product comprising:
a set of one or more computer-readable storage media;
program instructions, collectively stored in the set of one or more storage media, for causing a processor set to perform the following computer operations:
receiving a design of an object to be manufactured;
analyzing the design of the object to be manufactured to segment the object to be manufactured into components;
performing a comparative evaluation between wastage of materials and power consumption across different types of manufacturing processes to manufacture the components of the object;
calculating a sustainability score for each of the types of manufacturing processes for each of the components;
selecting a manufacturing process for each of the components based at least in part on the sustainability score for each of the types of manufacturing processes for each of the components; and
manufacturing each of the components using the selected manufacturing process for each of the components.

18. The computer program product of claim 17, wherein analyzing the design of the object to be manufactured to segment the object to be manufactured into the components comprises applying historical information to identify how the object can be segmented and manufactured as the components.

19. The computer program product of claim 17, wherein analyzing the design of the object to be manufactured to segment the object to be manufactured into the components is based at least in part on a specification of the object, a shape of the object, and dimensions of the object.

20. The computer program product of claim 17, wherein the sustainability score is calculated for each of the types of manufacturing processes based at least in part on parameters of the types of manufacturing processes.
